(19) United States
(12) Patent Application Publication
(10) Pub. No.: US 2009/0276294 A1
(43) Pub. Date: Nov. 5, 2009

(54) Career Framework

(75) Inventor: John T. Roecker, Yardley, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: PROJECT MANAGEMENT INSTITUTE, Newtown Square, PA (US)

(21) Appl. No.: 12/112,584

(22) Filed: Apr. 30, 2008

(51) Int. Cl. G06Q 10/00; G06F 9/44; G06Q 90/00

(52) U.S. Cl. 705/11; 705/7; 705/1

(57) ABSTRACT

A method and apparatus for assessing eligibility for a job including providing a job description to a user of a general purpose computer, providing a plurality of skills to a user of the general purpose computer, wherein the plurality of skills is particular to the job description, providing a plurality of skill levels for each of the plurality of skills to a user of a general purpose computer, the user performing an evaluation the user's abilities against each of the plurality of skills by assigning one of the plurality of skill levels to each of the plurality of skills, and the general purpose computer determining a user suitability for a particular job.

### FIELD OF INVENTION

This application is related to a career path tool for skill evaluation. More particularly, this application is related to a system and apparatus for skills evaluation and career planning for project managers.

### BACKGROUND

According to today's business executives, project management is a valued skill. Most project managers are overloaded as they must perform their regular work duties while overseeing their assigned projects. However, a majority of organizations do not have a career or management growth path for professional project managers. Voluntary resignations are on the increase, and Human Resource professionals are concerned that it is becoming increasingly difficult to retain skilled project managers.

Meanwhile, employees cite a number of reasons for voluntary resignations; for example, better opportunities for growth elsewhere, desires for new experiences and general dissatisfaction with advancement opportunities.

When viewed from an employee perspective, the best employee retention strategies include career development opportunities. Increased employee retention and employee satisfaction is most often attributed to process improvements, executive and career development programs, and linking competencies to skill levels and clearly developed roles.

### SUMMARY

A method and apparatus are disclosed to provide measurements of the readiness of human capital. This may include identification of job descriptions, skill levels and competencies and assessments of individuals in terms of the individual's abilities, background and training as compared to work descriptions, skill levels and competencies. This may also include developing career and job ladders with specific goals and expectations.

### BRIEF DESCRIPTION OF THE DRAWINGS

A more detailed understanding may be had from the following description, given by way of example in conjunction with the accompanying drawings wherein:

FIG. 1 shows a tiered pyramid structure of an overview of project management jobs in accordance with one embodiment;

FIG. 2 is a flow chart showing an overview of a career path tool in accordance with one embodiment;

FIG. 3 is an example of specific work information associated with the job titles shown in 1;

FIG. 4 is an example of an implementation of the detailed job assessment function in accordance with one embodiment;

FIG. 5 is an example of an implementation of the skill assessment function in accordance with one embodiment;

FIG. 6 is an example of a manage competencies screen in accordance with one embodiment;

FIG. 7 is an example of a create/edit competency screen in accordance with the edit function of FIG. 6;

FIG. 8 is an example of a manage skills screen in accordance with one embodiment;

FIG. 9 is an example of a create/edit skills screen in accordance with an edit or add selection of FIG. 8;

FIG. 10 is an example of a manage project profiles screen in accordance with one embodiment;

FIG. 11 is an example of a create/edit project profile screen in accordance with a selection from FIG. 10;

FIG. 12 is an example of a manage additional requirements screen in accordance with one embodiment;

FIG. 13 is an example of a create/edit additional requirements screen 1300 in accordance with an add/edit selection from the screen of FIG. 12;

FIG. 14 is an example of a manage job description screen in accordance with one embodiment;

FIG. 15 is an example of a create/edit job descriptions screen in accordance with an add/edit selection from the screen of FIG. 14;

FIG. 16 is an edit job description screen in accordance with one embodiment;

FIG. 17 is an example of a manage job ladders screen in accordance with one embodiment; and

FIG. 18 is an example of a create/edit job ladders screen 1800 in accordance with an add/edit selection from the screen of FIG. 17.

### DETAILED DESCRIPTION

Disclosed herein is a method and apparatus for a career path tool that allows users to objectively evaluate their skills and competencies against the skills and competencies that are required for a particular job. The user can perform a self-evaluation and the user may request that third parties perform evaluations. The user may then compare the evaluations against job requirements to determine, for example, the new skills the user must acquire to advance to a higher job level. While the career path tool is shown in terms of project management professionals, the methods and apparatus disclosed are not job or industry specific, and may be applied to many job functions across many industries.

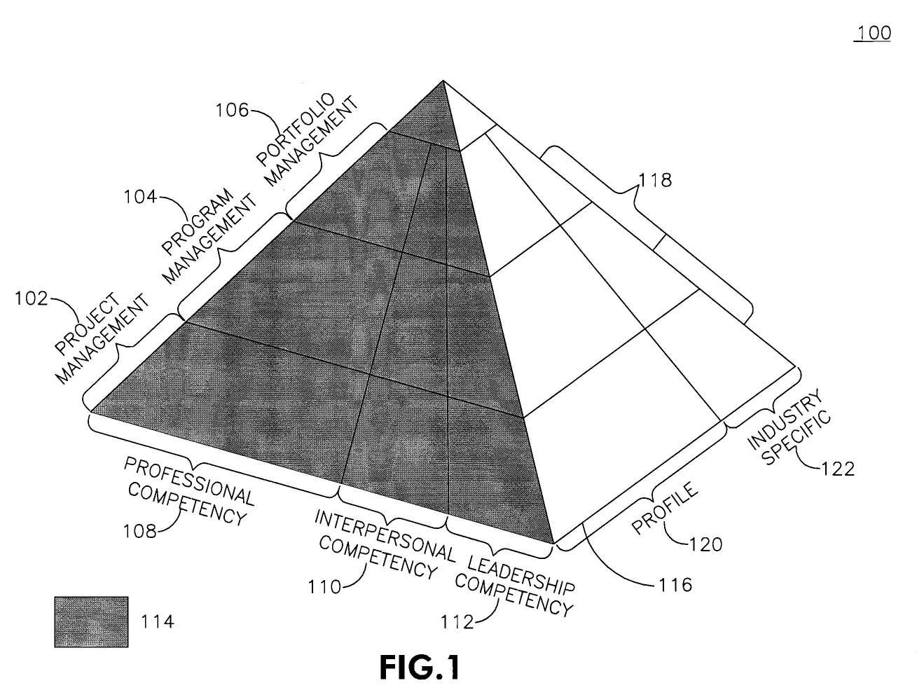

FIG. 1 shows a tiered pyramid structure 100 of an overview of project management positions with varying levels of skilled and responsibility. The pyramid 100 shows three job levels; project management 102, program management 104 and portfolio management 106. Each job level (102, 104, 106) includes multiple competencies. The multiple competencies are separated into three general categories, professional competencies 108, interpersonal competencies 110 and leadership competencies 112. The competencies 108, 110, 112 may be evaluated by evaluating an employee's individual skills 114 that are required to perform a particular job.

The base of the pyramid 116 represents a basic job level. As one moves up the pyramid, each layer of skills 118 builds on the layer below across all competencies 108, 110, 112. The skills 114 and the competencies 108, 110, 112 may be evaluated across multiple job profiles 120 and multiple industries 122.

A flow chart showing an overview of a career path tool 200 from the view point of a non-administrative user in accordance with one embodiment. At a method start 202, the user is offered a choice of functions, including work descriptions 204, work assessments 206, job ladders 208, career framework 210, user profile 212, and contact 214. These choices are always available to the user. At any point in the process, the user may choose to use any one of these functions.

The work description function 204 includes a detailed job list function 216. The detailed job list function 216 includes detailed listings of the responsibilities of each individual job function 218. Each individual job function 218 also offers the user the ability to choose a skill assessment function 220 or a project profile function 222.

The job assessment function 206 allows the user, or a user's representative, to compare a job candidate, who is generally the user, to a specific job. The user can start a job assessment function 206, which allows the user to evaluate the user's abilities and background against a list of qualifications and requirements for a particular job. The user may also request that a third party perform the same analysis, and return the results to the user. As the user performs the assessments and has a third party perform the assessments, the user may see a summary of completed assessments 226.

The job ladders function 208 includes a suggested sequence of jobs based on the goals of the user. For example, in order to reach a senior position, the ladder function may suggest one or more junior positions that should be attained in order to reach each senior position. The job ladder function includes access to the job list function 216 and allows the user to see a detailed job ladder 228. A user may then access the individual job descriptions 218 and perform a skills assessment 230.

A career framework function 210 includes a set of sample work descriptions specifically in the field of project management. This function may be used as a guide to build custom work descriptions, or pre-programmed samples can be used as provided. The career framework function 210 allows the user to use the work description function 216 or the job ladders function 208, as well as providing access to project profiles 222. Additionally, the career framework function 210 includes skills 232, competencies 234 and additional requirements 1536.

The profile function 212 includes user profile information, such as name, password and the like. The contact function 214 is a mail function that allows the user to contact an administrator or other individual for help, guidance, information, comments and the like.

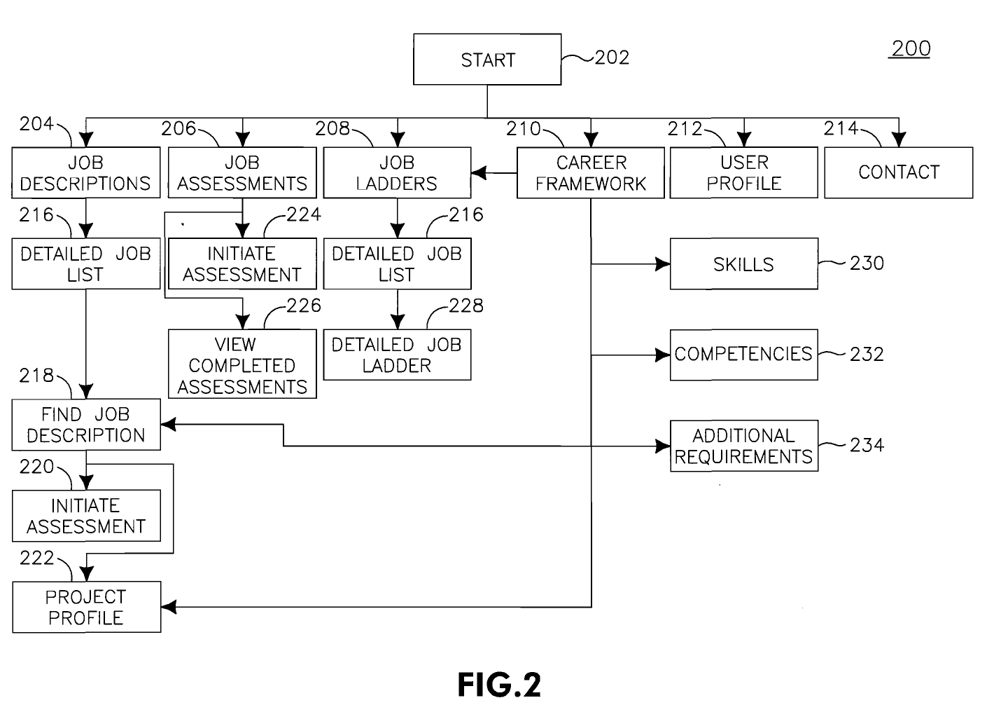

Table 1 shows a job list from the job list function 216 of FIG. 2. The table includes titles of each specific job included in the work description function 204 of FIG. 2. For example, 1 includes job titles for project manager I, project manager II, project manager III, program manager and portfolio manager. A user may select one of the job titles to obtain more specific information regarding the selected job. The jobs may be listed in any order.

TABLE 1
JOB LIST

Portfolio Manager
Program Manager
Project Manager III
Project Manager II
Project Manager I

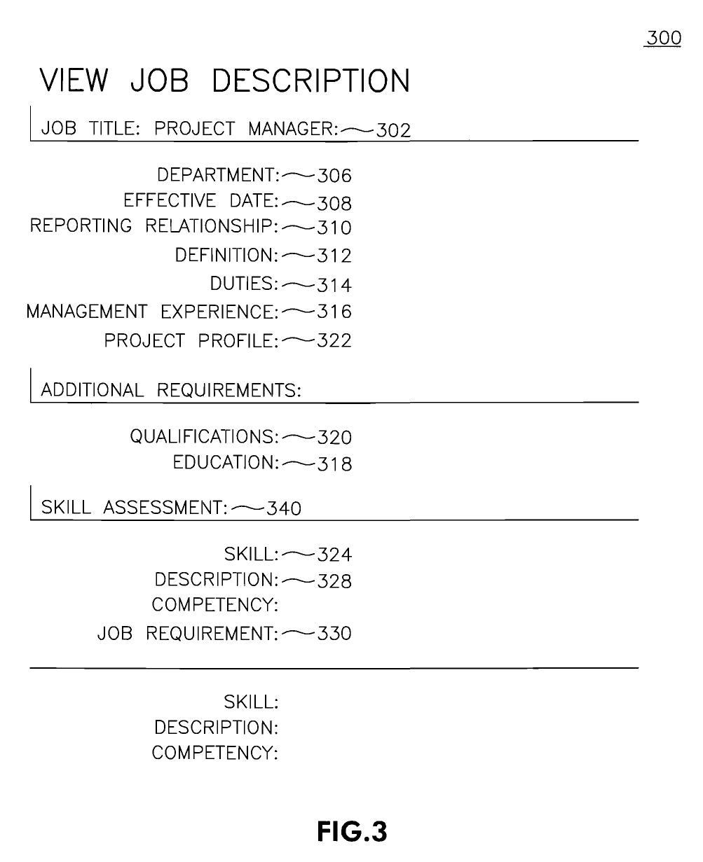

FIG. 3 is an example of specific work information 300 associated with the job titles shown in 1. In this example, the job title 302 is Project Manager I. The specific work information 300 includes background information, such as the department 306 in which the job is assigned, effective dates of background information 308, and a reporting relationship 310. The definition 312 of the job and general duties 314 of the job. Also included is required management experience 316 and access to a project profile 322.

Details 318 of additional requirements 236 (FIG. 2) are also shown in FIG. 3. The additional requirements 336 may include educational requirements 320 and professional qualifications 322, such as professional trade group membership, professional certifications and the like.

Details of a list 340 of the required skills 232 (FIG. 2) are also included in specific job information. The details may include a short description of the skill 324, an identifying label 326, a long description of the skill 328, a competency 134 (FIG. 1) and job requirement level 330.

Each skill is related to a particular competency 134. Competency 134 may be separated into three levels, for example. The levels may be professional, interpersonal and leadership. Each skill is, therefore, a professional skill, an interpersonal skill or a leadership skill.

Each skill is also related to a skill level. The skill level may be, for example, 0 through 4. Level 0 may represent a skill level that is not applicable for a particular job description. Level 1 may represents a skill level where knowledge of the skill is required, but the ability to apply the skill is not required. Level 2 may represent a skill that the candidate should have the ability to apply, with supervision. The skill may be required for the particular job. Level 3 may represent a skill that the candidate should have the ability to apply independently. The skill may be required for the job. Level 4 may represent a skill that the candidate should have the ability to apply at a mastery level, and is required for the job.

Within the work description function 204 (FIG. 2) or from the career framework function 210 (FIG. 2), the user may perform an assessment of his or her skills, competencies and background versus the requirements of a particular job. For example, a user may choose a particular job title from a list to obtain a list of specific skills required for the job. Each listed skill includes an assessment level that the user may choose for self-evaluation. Skill levels are assigned from 0 to 4, as stated above. The user may assess himself on the 0 to 4 scale for each skill and save the results. The user may then compare that assessment to any job listed in the job function to judge his or her qualifications, and to see where the user may need to improve or learn new skills for advancement up the career ladder.

Furthermore, the user may request that a third party evaluate the user by utilizing the same set of skills and levels as is used for self-assessment. The user may invite a third party to perform the assessment by sending the third party a message that contains the job description, skill listings and skill assessment levels. The third party may then rate the user's skills and qualifications, and save that data. The user may retrieve the data at any time after it is saved by the third party, so that the user may view how others perceive the user's skills, as compared to the user's evaluation.

The functions may be implemented in software, on one or more general purpose computers, in any computer language that is applicable. The functions may further be implemented in a computer system that communicates through a worldwide computer network, such as the World Wide Web. The software may reside on a first computer, while a user accesses the software from a second computer, across any communication network. The hardware and the communications network are well known to those skilled in the art, and no embodiment set forth herein is limited to any particular hardware, language or communications network.

In one embodiment, the functions may be implements in a web-based system. The user may view the functions as “screens” that are retrieved from a remote computer, viewed or manipulated by the user, with results being saved on the remote computer. Each function may be graphically represented on a different screen containing lists of data, drop-down boxes and hyperlinks to other functions.

For example, on a first screen, the job description function 204, the job assessment function 206, the job ladder function 208, the career framework function 210, the profile function 212 and the contact function 214 may appear as hyperlinks in a list form on, for example, the left side of a screen. Moving a cursor onto one of the hyperlinks and “clicking” on any one of the function names, using a process that is well known in the art, opens a second screen for the user.

The second screen may contain more detailed information about a function listed on the first screen. For example, by clicking on the job description function hyperlink, the second screen may present a list of job titles. Each of the job titles in the list may also be hyperlinks. Again, moving a cursor over one of the job titles and clicking on the hyperlink or pressing the enter key, may open a third screen.

The third screen may include detailed information regarding the item chosen from the second screen. For example, if the job title chosen in the second screen is “associate project manager”, the third screen may contain a list of background information regarding the associate project manage job, a list of required background and education, and a list of skills and competencies required.

A fourth screen may graphically represent individual job description function 218. The screen may represent the background information in a list that includes department, effective date, reporting relationship, and management experience and project profile. Project profile may be seen as a hyperlink to another screen that shows details of the project for which this associate project manager job was created.

The fourth screen may show the additional requirements function and include education and other qualifications, such as professional organization membership or credentials. Required skills may be shown as a list of specific skills. Each skill is described in detail, and has an associated identifying label. Each skill also is related to one of three particular competencies; professional, interpersonal and leadership. Each skill also has a required skilled level associated with that skill for that particular job description. The skills levels, 0 through 4, are described herein.

Should a user select the “project profile” hyperlink, they will be directed to another screen that includes specific project information. This information may include, a development cost range, a team size value range, duration of the project, speed of development project, level of risk, span of impact within the organization, number of interfaces, number of geographical regions, number of function disciplines/stakeholders, number of sub-projects, level of innovation to achieve goals and project scope definition.

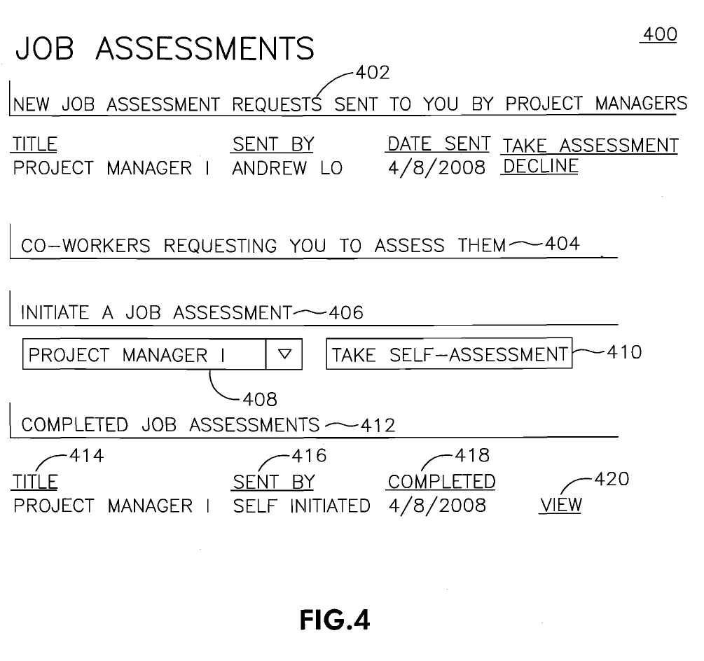

Referring back to the first screen, a user may select the job assessments hyperlink, and be presented with a screen that includes more detail of the job assessment function. FIG. 4 is an example of an implementation of the job assessment function 400 in accordance with one embodiment. The user is presented with four categories. The first category 402 is captioned “New Job Assessment Requests sent to you by Managers”. Underneath this caption may be a list of job descriptions, in drop-down box format, of all jobs that a manager has requested a user to assess themselves against. The program allows users, with the proper privileges, to request that other users perform a job assessment. In this manner, a manger may ensure that a user is assessing himself against the job requirements for a job he may already have, or perhaps for a job that a manager may believe the user may move into.

A second category 404 is the “Co-workers Requesting You to Assess Them”. Underneath this caption may be a list of job descriptions and co-worker names, in hyperlink or drop-down box format, that are requesting that the user assess the co-worker against the requirements of the co-worker's job. The user is in the position of a third party assessor. The co-worker may request multiple third parties to perform an assessment and only the co-worker knows how many different third parties have been requested to do an assessment. Furthermore, only the co-worker may see the various assessments that have been performed on the co-worker's behalf. While performing an assessment, the third party may see the same job information as a user who performs a self-assessment, only the third party may not access any other parts of the system.

A third category 406 is “Initiate a Job Assessment”. Under this caption is a drop-down box 408 that includes a list of job titles available to the user. The user may select a job title from the drop-down box and click on “take the self-assessment” hyperlink 410 located next to the drop-down box. This will allow the user to open a job assessment screen.

A fourth category 412 is “Completed Job Assessments”. Under this caption is a list of job assessments that have been completed, listed by job title 414, the person who performed the assessment 416, and the date completed 418. A hyperlink entitled “view” 420 is positioned next to each completed assessment. When a user clicks on the “view” hyperlink, a screen showing details of a completed job assessment is shown to the user.

A user may enter the job assessment function from a number of different screens. For example, as stated above, the user may begin the job assessment function from the “Job Assessment” screen 400 by clicking on the “Take Self-Assessment” hyperlink 410. Third parties may also initiate a job assessment if requested by a user. For example, when a user requests a third party to perform a job assessment, an electronic message, such as an e-mail, is sent to the third party. The electronic message contains a link to the job assessment function where the third party may perform a job assessment in the same manner that a user performs the assessment. However, once the third party completes the assessment and the assessment is saved, the third party cannot continue to use any other function and is logged out of the system.

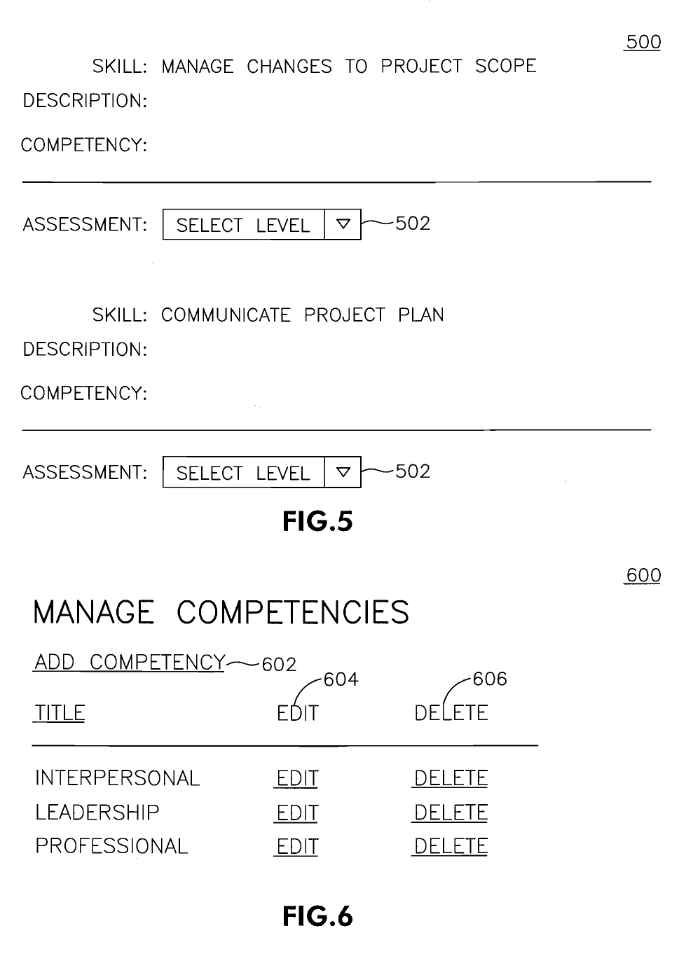

FIG. 5 is an implementation 500 of the detailed skill assessment function 500 in accordance with one embodiment. The skill assessment function 230, in appearance, is almost identical to the individual job description function 218. However, included in each detailed skills description is a drop down box 502 with values 0 through 4. The user may choose one of these values as the level at which the user believes he or she is performing a particular skill. As the user rates his or her performance at each skill level, a profile is formed of the user. This skills profile is saved and can be used to help the user attain or improve certain skills and maintain others that may be necessary for the user to advance to more responsible positions within an organization.

If the skill assessment is being performed by a third party, the third party would use the same implementation as the user. For example, if a third party was performing an evaluation of the user for the project management job shown in implementation 500, the third party would select a value from each drop-down box 500 that corresponded to the assessed skill level of the user. When the evaluation is complete, the third party may save the evaluation, and may be prevented from viewing any other screens.

The Job Descriptions, Job Ladders, Competencies, Project Profiles, Additional Requirements and Skills may be added, deleted and/or edited. An administrator may have access to the add, delete and/or edit functions, while a user may be limited only to viewing the functions and performing assessments.

FIG. 6 is an example of a manage competencies screen 600 in accordance with one embodiment. Competencies may be added 602, edited 604 or deleted 606 to meet organizational requirements.

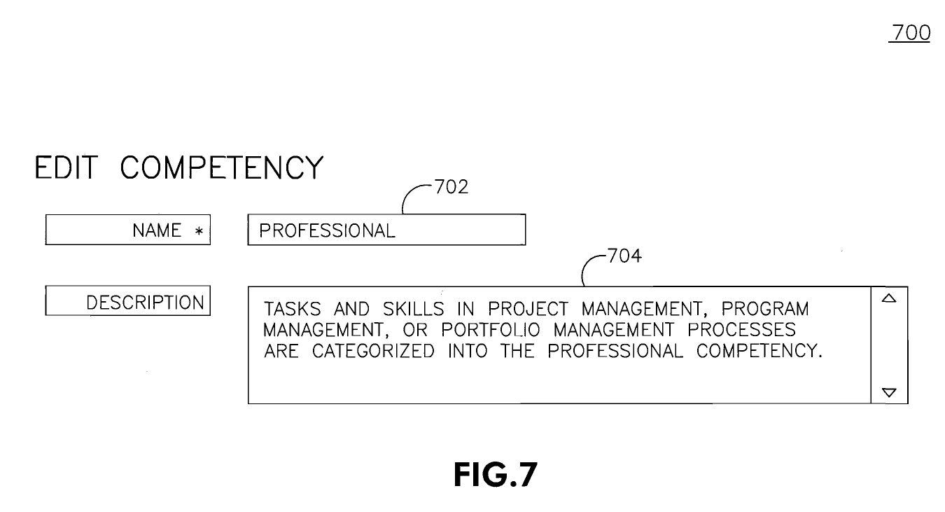

FIG. 7 is an example of a create/edit competency screen 700 in accordance with the edit function of FIG. 6. The name of a competency may be added or edited 702, and the description of the competency may also be added or edited 704.

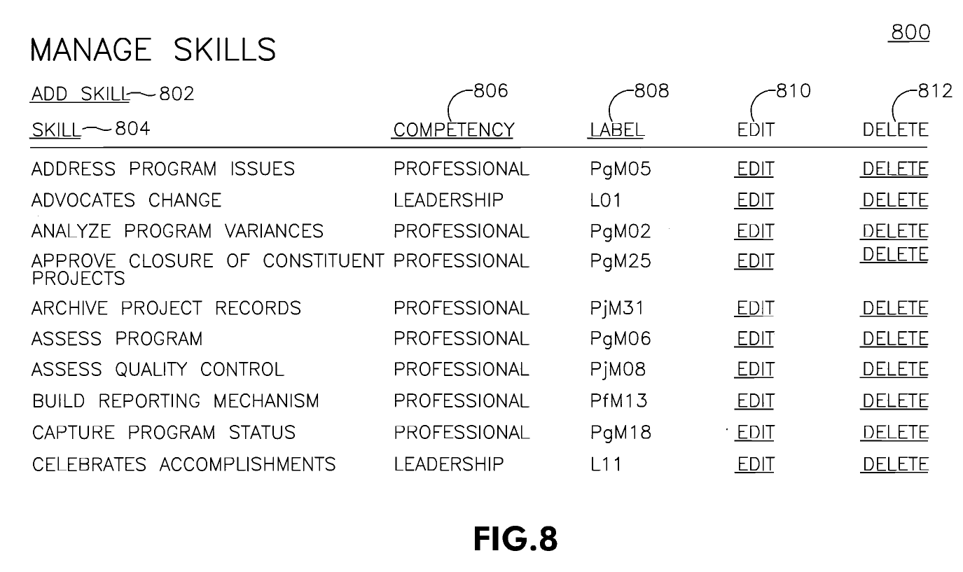

FIG. 8 is an example of a manage skills screen 800 in accordance with one embodiment. The manage skills screen 800 includes hyperlinks to other screens that allow the user to add a skill, delete a skill or customize a skill to meet organizational requirements. Skills may be sorted by selecting column headers. Selecting the Skill header 804 will sort the library of skills by skill title. Selecting Competency 806 will sort the library of skills by competency and selecting Label 808 will sort the library of skills by skill label

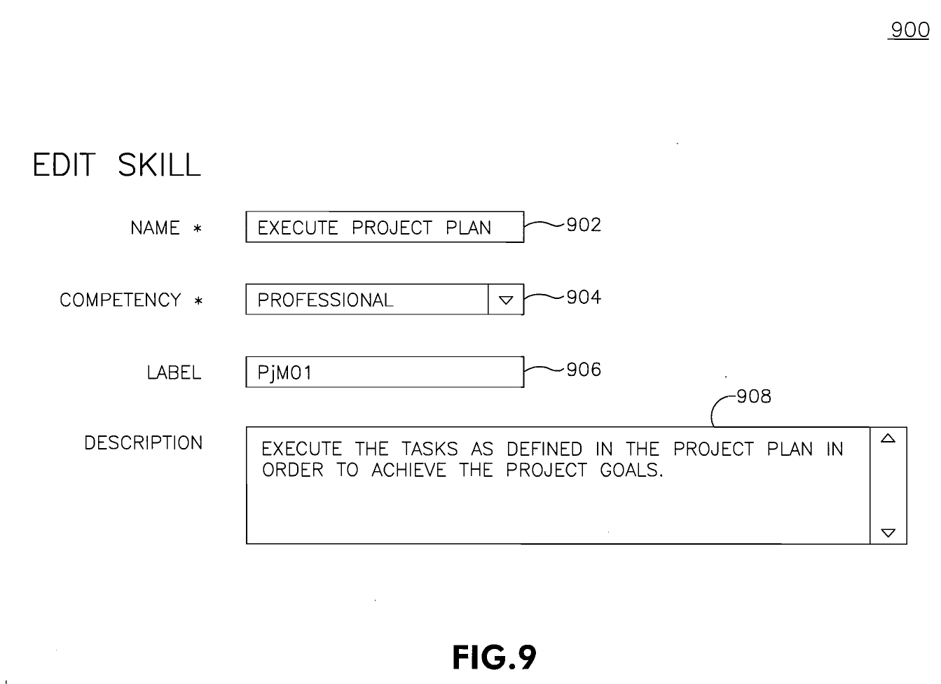

FIG. 9 is an example of a create/edit skills screen 900 in accordance with an edit or add selection of FIG. 8. A individual skill may be added or edited by modifying the contents of the Name field 902, the Label filed 906 and/or the Description field 908. The Competency can be changed by a selection from the Competency drop down list 904.

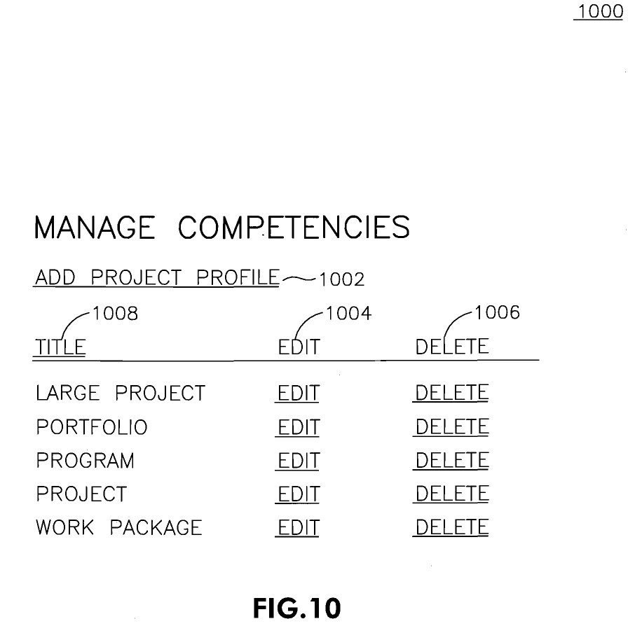

FIG. 10 is an example of a manage project profiles screen 1000 in accordance with one embodiment. A project profile may be added by selecting the add Project Profile hyperlink 1002. Also shown are hyperlinks used for editing a profile 1004 and deleting a profile 1006. The profiles may be sorted by Title 10008.

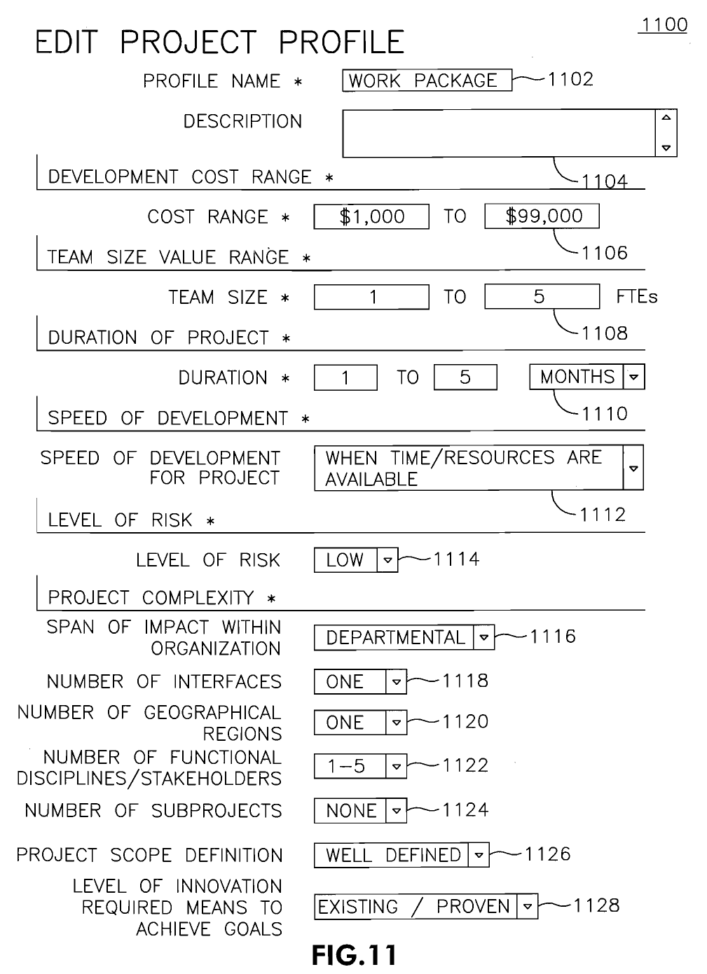

FIG. 11 is an example of a create/edit project profile screen 1100 in accordance with a selection from FIG. 10. Project profiles may be edited by modifying the profile name 1102 and description of the profile 1104. The cost range 1106 and team size 1108 variables may be modified. The duration field 1110 variables may be modified as well as the value of the variables (Days/Months/Years) 1112. Additionally, project complexity fields may be modified and include span of impact within organization 1116, number of interfaces 1118, number of geographical regions 1120, number of functional disciplines/stakeholders 1122, number of subprojects 1124, project scope definition 1126 and level of innovation required/mean to achieve goals 1128 variables may be modified by selecting variables from the relative drop-down fields.

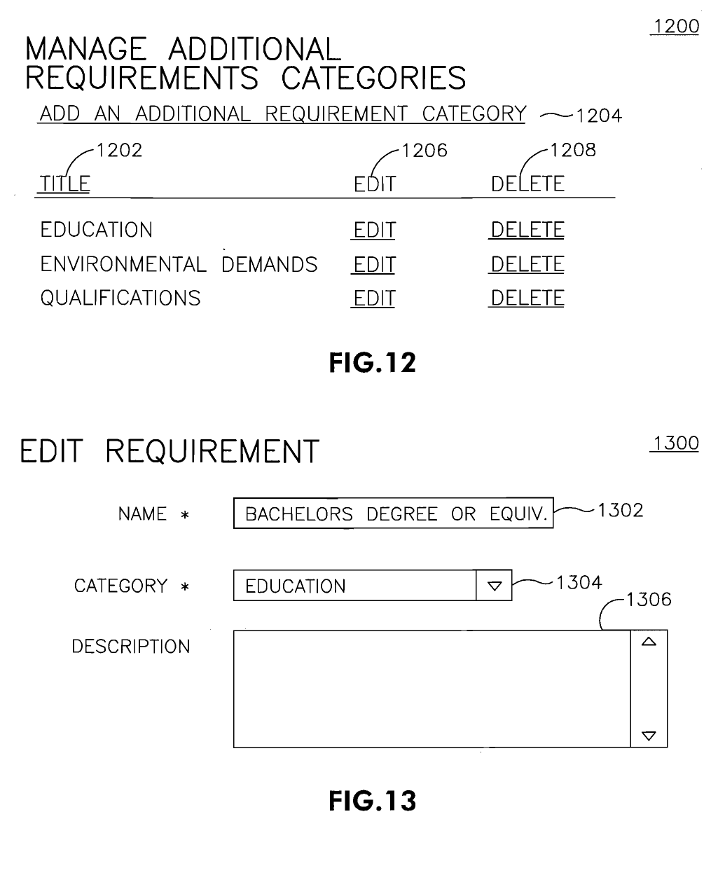

FIG. 12 is an example of a manage additional requirements screen 1200 in accordance with one embodiment. Additional requirements categories may be sorted by selecting the Title header 1202. An additional requirements category may be added by selecting a hyperlink 1204. Additional requirements may also be edited by selecting an edit hyperlink 1206 or deleted by selecting a delete hyperlink 1208.

FIG. 13 is an example of a create/edit additional requirements screen 1300 in accordance with an add/edit selection from the screen of FIG. 12. Adding a new requirement or editing an existing requirement may be accomplished modifying the contents of the Name field 1302 and Description field 1306 and selecting a Category 1304 from the drop-down list of existing categories.

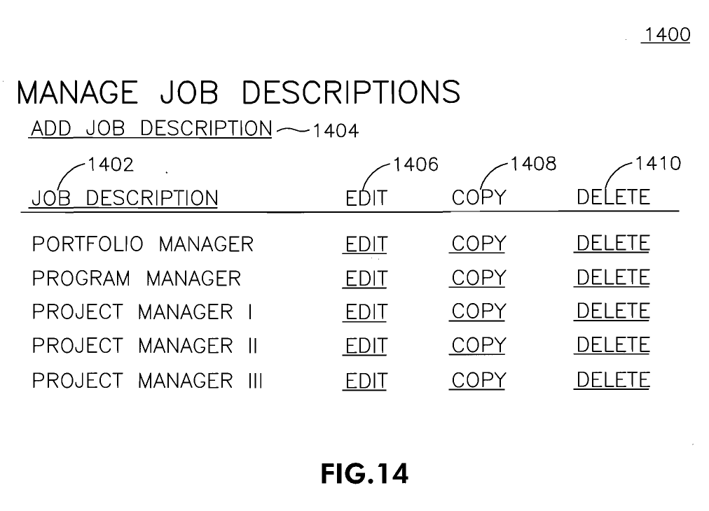

FIG. 14 is an example of a manage job description screen 1400 in accordance with one embodiment. The manage job description screen 1400 shows a list of job descriptions for an organization. Job descriptions may be sorted by selecting the Job Description header 1402. A job description may be added by selecting the add job description hyperlink 1404. Jobs descriptions may also be edited by selecting the edit hyperlink 1406, copied by selecting the copy hyperlink 1408 or deleted by selecting the delete hyperlink 1410.

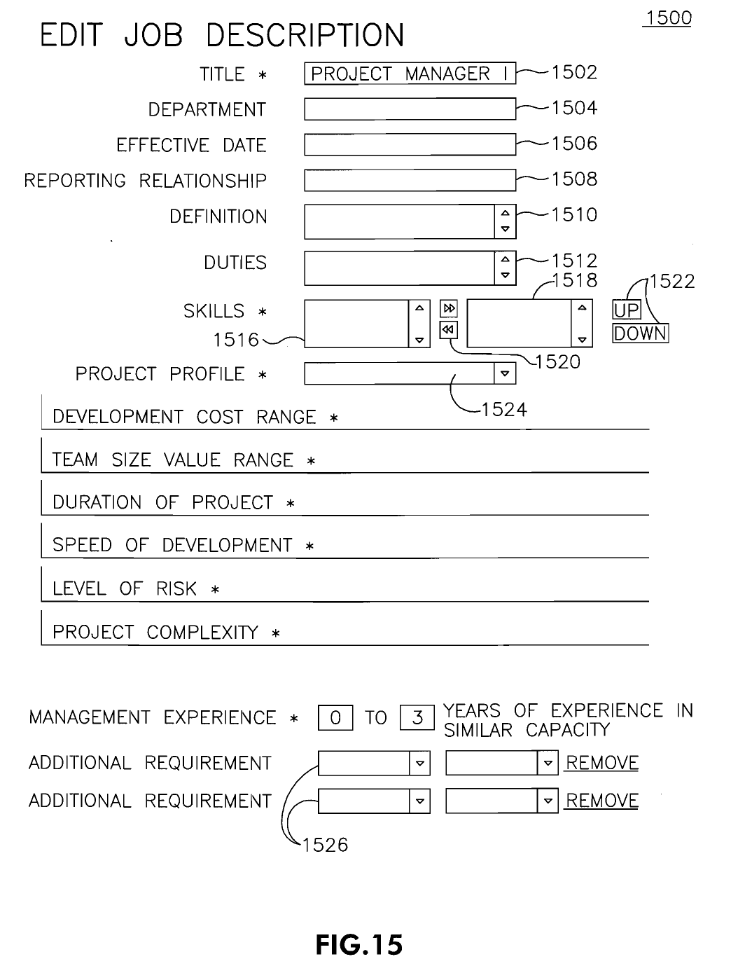

FIG. 15 is an example of a create/edit job descriptions screen 1500 in accordance with an add/edit selection from the screen of FIG. 14. Adding a new job description or editing an existing job description may be accomplished modifying the contents of the Title 1502, Department 1504, Effective Date 1506, Reporting Relationship 1508, Definition 1510 and Duties 1512 fields. The skills appropriate for a particular job description may be selected from an inventory of available skills 1516 and moved into the list of skills selected for this job description 1518 by using the arrows 1520. The list of skills in a job description may be sequenced using the up and down buttons 1522. A project profile for which this job is responsible is selected from the list of existing project profiles using a drop-down 1524 and additional requirements are selected from the list of additional requirement categories and additional requirements for the selected category using drop-downs 1526. When the job description is complete, the submit button 1528 may be selected.

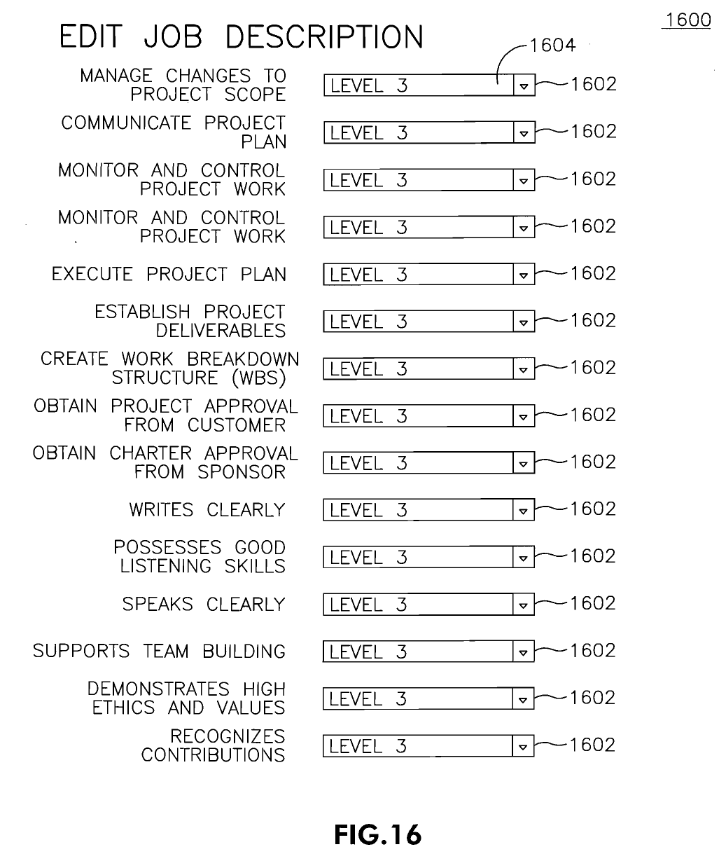

FIG. 16 is an edit job description screen 1600 in accordance with one embodiment. Edit job description screen 1600 is initiated after the submit button 1528 of FIG. 15 is selected in order to aid the process of selecting a level of proficiency for each skill selected in FIG. 15. Each skill from the skills box 1518 of FIG. 15 is listed in FIG. 16 with a drop down box that includes the proficiency levels. The user may select a proficiency level 1604 from each drop down box 1602 for each skill 1528.

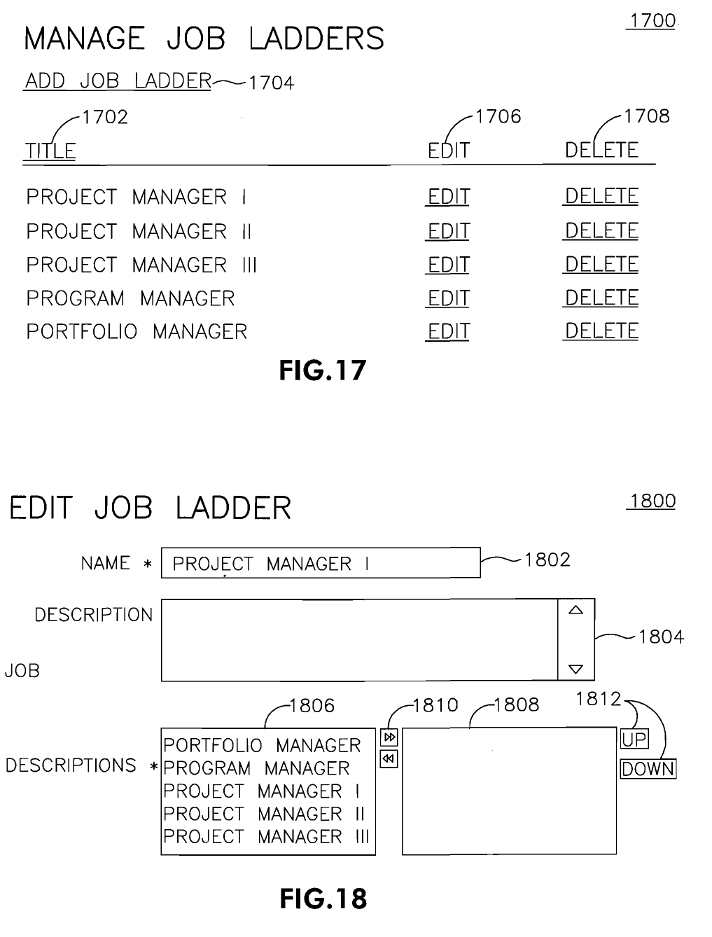

FIG. 17 is an example of a manage job ladders screen 1700 in accordance with one embodiment. The manage job ladders screen 1700 shows a list of job titles for an organization. Job titles may be sorted by selecting the Title header 1702. A job title may be added to a job ladder by selecting the add job ladder hyperlink 1704. Jobs descriptions may also be edited by selecting the edit hyperlink 1706 or deleted by selecting the delete hyperlink 1708.

FIG. 18 is an example of a create/edit job ladders screen 1800 in accordance with an add/edit selection from the screen of FIG. 17. An individual job ladder may be added or an existing job ladder may be edited by modifying the contents of the Name filed 1802 and Description field 1804. The sequence of jobs followed to reach the job listed in the Name field 1802 are selected from the inventory of available job descriptions 1806 and moved into the list of jobs to follow for this job description 1808 by using the arrows 1810. The list of jobs to follow may be sequenced using the up and down buttons 1812.

After the assessments are completed, a user may generate a report that gives the user a detailed synopsis. A detailed synopsis may include the user's current job description; the skills associated with that the current job description, and all assessments of the user's skills as compared to the current job description. The detailed synopsis may also include a comparison of the user's skills to a job the user may be interested in. The detailed synopsis may provide the user with a listing of skills that have been mastered and another listing of skills that need improvement for a user to achieve a satisfactory rating for the user's current job, or to meet the requirements for the next job in the job ladder. The detailed synopsis may provide a list of jobs that may fit the user's skill levels as well as or better than the user's current job. The detailed synopsis may highlight skills that have been assessed by a third party at a particular level while the user has self-assessed that skill at a dramatically different level.

A general synopsis may include all the information included in a detailed synopsis, but without some details. For example, the general synopsis may only show an average of all skills assessed rather than each individual skill. Further, a general synopsis may include a warning flag that indicates that a self-assessment is radically different than a third party assessment, with a prompt to allow the user to see the details. The general synopsis may include a gross number of skills, number of skills mastered and number of skills requiring more attention, with a prompt to see the details. The general synopsis may include a list of jobs for which the user is qualified, with a prompt allowing the user to select one or more jobs to obtain more detail.

At an administrative level, an administrator may select to view all users that have attained a certain level of one or more skills, or have met certain requirements for a particular job description. An administrator may see all assessments performed for a particular user in detail, including the identities of the assessors, and obtain a list of skills that the user has mastered and/or that require more attention from the user. An administrator may identify a job description, with a list of skills, and obtain a list of all users that meet or exceed the required skill levels. An administrator may request to see a list of skill levels and a number of employees that have attained certain skills at certain levels, in order to design organizational training or to analyze organizational weaknesses and strengths. The method may be linked to particular training programs which can be offered to users who require training to a particular skill or set of skills, such that the user is offered the training automatically after the assessments are completed, or the administrator can view recommended training for individuals or the organization.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A method of assessing eligibility for a job, the method comprising:
providing a job description to a user of a general purpose computer;
providing a plurality of skills to the user of the general purpose computer, wherein the plurality of skills is particular to the job description;
providing a plurality of skill levels for each of the plurality of skills to the user of the general purpose computer;
the user performing an evaluation the user's abilities against each of the plurality of skills by assigning one of the plurality of skill levels to each of the plurality of skills; and
the general purpose computer determining a user suitability for a particular job.

2. The method as in claim 1 further comprising:
the user sending an electronic message across a world-wide communications network to request a third party to perform the evaluation; and
the third party performing the evaluation.

3. The method as in claim 2 wherein the third party is a supervisor of the user.

4. The method as in claim 2 wherein the third party is a peer of the user.

5. The method as in claim 1 further comprising using the evaluation as a basis for employee hiring and promotion.

6. The method as in claim 1 further comprising the general purpose computer using the evaluation as a basis for employee training.

7. The method as in claim 6 further comprising the general purpose computer recommending specific employee training to the user.

8. The method as in claim 1 further comprising:
providing a plurality of job descriptions;
providing a plurality of skills, wherein the plurality of skills is particular to the plurality of job descriptions;
providing a plurality of skill levels for each of the plurality of skills; and
the general purpose computer determining a user's suitability for a series of jobs.

9. The method as in claim 7 further comprising the general purpose computer determining a plurality of future skills, wherein the future skills are skills required by the user for future employment.

10. A method to enable an organization to identify organizational developmental needs, the method comprising:
providing a plurality of job descriptions to users of a general purpose computer;
providing a plurality of skills to the users of the general purpose computer, wherein the plurality of skills is particular to each of the plurality of job descriptions;
providing a plurality of skill levels for each of the plurality of skills to the users of a general purpose computer;
the users performing an evaluation of each of the users' abilities against each of the plurality of skills by assigning one of the plurality of skill levels to each of the plurality of skills; and
the general purpose computer determining at least one skill requiring improvement based on the evaluations.

11. The method as in claim 10 further comprising:
the users transmitting a message over a network, wherein the message includes a request to a third party to perform a third party evaluation of the users' skills;
the third party performing the third party evaluation and transmitting the third party evaluation to the general purpose computer; and
the general purpose computer determining at least one skill requiring improvement based on the evaluations and the third party evaluations.

12. The method as in claim 10 further comprising the general purpose computer:
determining recommended training based on the skill requiring improvement; and
informing the user of the recommended training.

13. A computer configured to determine a candidate pool for a particular employment opportunity; the computer comprising:
a memory unit configured to hold:
a plurality of job descriptions;
a plurality of skills particular to each of the plurality of job descriptions; and
a plurality of skill levels for each of the plurality of skills;
an input/output unit, coupled to the memory unit, the input/output unit configured to allow a plurality of users to:
perform an evaluation of each of the users' abilities against each of the plurality of skills by assigning one of the plurality of skill levels to each of the plurality of skills; and
a processor unit configured to compare the evaluations to the particular employment opportunity and determine a candidate pool based on the comparison.

14. The computer as in claim 13 further comprising:
a networking unit configured to communicate with a third party evaluator.

15. The computer as in claim 14 wherein the memory unit is further configured to hold third party evaluations received from the third party evaluator.

16. The computer as in claim 15 wherein the processor unit is further configured to compare evaluations and third party evaluations to the particular employment opportunity.

17. A computer configured to determine a career path; the computer comprising:
a memory unit configured to hold:
a plurality of job descriptions;
a plurality of skills particular to each of the plurality of job descriptions; and
a plurality of skill levels for each of the plurality of skills;
an input/output unit, coupled to the memory unit, the input/output unit configured to allow a user to:
perform an evaluation of the user's abilities against each of the plurality of skills by assigning one of the plurality of skill levels to each of the plurality of skills; and
a processor unit configured to compare the evaluations to the plurality of jobs descriptions to determine the user's career path and training requirements.

18. The computer as in claim 17 further comprising:
a networking unit configured to communicate with a third party evaluator.

19. The computer as in claim 17 wherein the memory unit is further configured to hold third party evaluations received from the third party evaluator.

20. The computer as in claim 17 wherein the processor unit is further configured to compare evaluations and third party evaluations to the particular employment opportunity.
